(19) United States
(12) Patent Application Publication
(10) Pub. No.: US 2023/0194822 A1
(43) Pub. Date: Jun. 22, 2023

(54) LENS ASSEMBLY

(71) Applicant: AAC Optics (Suzhou) Co., Ltd., Suzhou City (CN)

(72) Inventor: Jian Bu, Shenzhen (CN)

(21) Appl. No.: 17/833,765

(22) Filed: Jun. 6, 2022

(30) Foreign Application Priority Data
Dec. 16, 2021 (CN) 202123157936.X

(51) Int. Cl. G02B 7/02

(52) U.S. Cl. CPC G02B 7/021; G02B 7/026; G02B 7/025

(57) ABSTRACT

The present disclosure provides a lens assembly, including: a lens barrel; a lens group with an optical axis accommodated in the lens barrel; a pressure ring arranged on an image side of the lens group and abutting against the lens group; and an optical filter abutting the pressure ring; where the pressure ring includes a first outer wall and an adhesive storage groove connected to the first outer wall and close to the image side; the lens assembly further comprises an adhering part, where the optical filter and the inner wall are arranged to space apart from each other to form an adhesive filling channel, and the adhering part fills the adhesive filling channel and is connected to the adhesive storage groove, the platform part, the inner wall and the optical filter. Compared with the related art, the above-mentioned lens assembly has a large overall thrust and good reliability.

### TECHNICAL FIELD

The present disclosure relates to the field of optical lenses, and in particular relates to a lens assembly.

### BACKGROUND

In recent years, with the development of camera technology and rise of electronic products with photography functions, optical camera modules have been widely used in various products, such as mobile phones.

A lens assembly in the related art includes a lens barrel, a lens group, a pressure ring and an optical filter. During assembly, the lens group and the pressure ring are first installed in the lens barrel, and then the optical filter is installed in the lens barrel and is adhered to the lens barrel by glue. There is no gap, however, between the optical filter and the lens barrel, and the glue cannot penetrate between the optical filter and the lens barrel, thereby only the ends of the optical filter away from the lens group are adhered to the lens barrel. Thus, the resulting bonding is not firm, and the optical filter is liable to fall off, thereby causing the pressure ring to float, and finally causing failure of the lens assembly.

In view of the above, there is a need for a new lens assembly to solve the above technical problems.

### SUMMARY

The present disclosure aims to provide a lens assembly with an optical filter not being liable to fall off and with a pressure ring not being liable to float.

To this end, the present disclosure provides a lens assembly, including: a lens barrel, a lens group with an optical axis accommodated in the lens barrel, a pressure ring arranged on an image side of the lens group and abutting against the lens group, and an optical filter abutting the pressure ring. An outer diameter of the optical filter is larger than an outer diameter of the pressure ring, the lens barrel includes a cylinder with an accommodating space, and the lens group, the pressure ring and the optical filter are accommodated in the accommodating space. The cylinder includes a boss and an inner wall connected to the boss, and the inner wall is arranged at an end of the cylinder close to the image side. The pressure ring includes a first outer wall and an adhesive storage groove connected to the first outer wall and close to the image side, the boss includes a platform part and a side wall part that are connected to each other, and the side wall part abuts against the first outer wall. The lens assembly further includes an adhering part, where the optical filter and the inner wall are arranged to space apart from each other to form an adhesive filling channel, and the adhering part fills the adhesive filling channel and is connected to the adhesive storage groove, the platform part, the inner wall and the optical filter.

As an improvement, the optical filter includes a second outer wall, and a distance between the second outer wall and the inner wall is greater than 50 microns.

As an improvement, the lens barrel further includes a plurality of positioning parts provided on the inner wall, and the optical filter is positioned by the plurality of positioning parts.

As an improvement, the plurality of positioning parts are arranged in a form of a circular array on the inner wall.

As an improvement, a distance between an end away from the inner wall of a positioning part of the plurality of positioning parts and the inner wall is less than 20 microns.

As an improvement, the inner wall is arc-shaped, and the plurality of positioning parts are arc-shaped lugs protruding from the inner wall to the optical axis.

Compared with the related art, the optical filter and the inner wall of the lens barrel of the lens assembly according to the present disclosure are arranged to space apart from each other, so that adhesive can flow to the pressure ring along the inner wall and form the adhering part by curing, thereby the lens barrel, the optical filter and the pressure ring can be reinforced and connected in one piece. In this way, firmness of the bonding between the optical filter, the pressure ring and the lens barrel can be ensured, the overall thrust of the lens assembly can be improved, and the reliability of the lens assembly can be increased.

### BRIEF DESCRIPTION OF DRAWINGS

For the purpose of illustrating the technical solutions according to embodiments of the present disclosure more clearly, the drawings used in the description of the embodiments are briefly described hereinafter. Obviously, the drawings in the following description are only some embodiments of the present disclosure. For those skilled in the art, other drawings can be obtained from these drawings without any inventive work.

FIG. 1 is a schematic diagram of a frontal projection structure of a lens assembly according to the present disclosure, the lens assembly includes a lens barrel.

FIG. 2 is a structural schematic diagram of the lens barrel of the lens assembly as shown in FIG. 1.

FIG. 3 is a sectional view taken along line A-A in FIG. 1.

FIG. 4 is a partial enlarged view of portion C as shown in FIG. 3.

### DETAILED DESCRIPTION OF EMBODIMENTS

The technical solutions according to embodiments of the present disclosure will be clearly and completely described below with reference to the accompanying drawings in the embodiments of the present disclosure. Obviously, the described embodiments are only a part of the embodiments of the present disclosure, but not all of them. Based on the embodiments of the present disclosure, other embodiments which can be obtained by those skilled in the art without inventive work shall fall within the protection scope of the present disclosure.

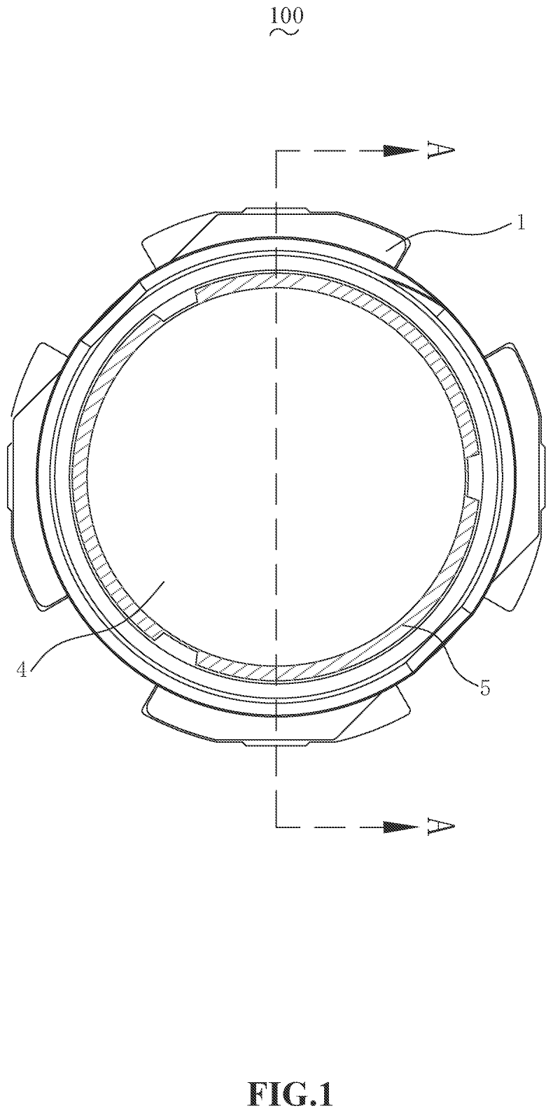

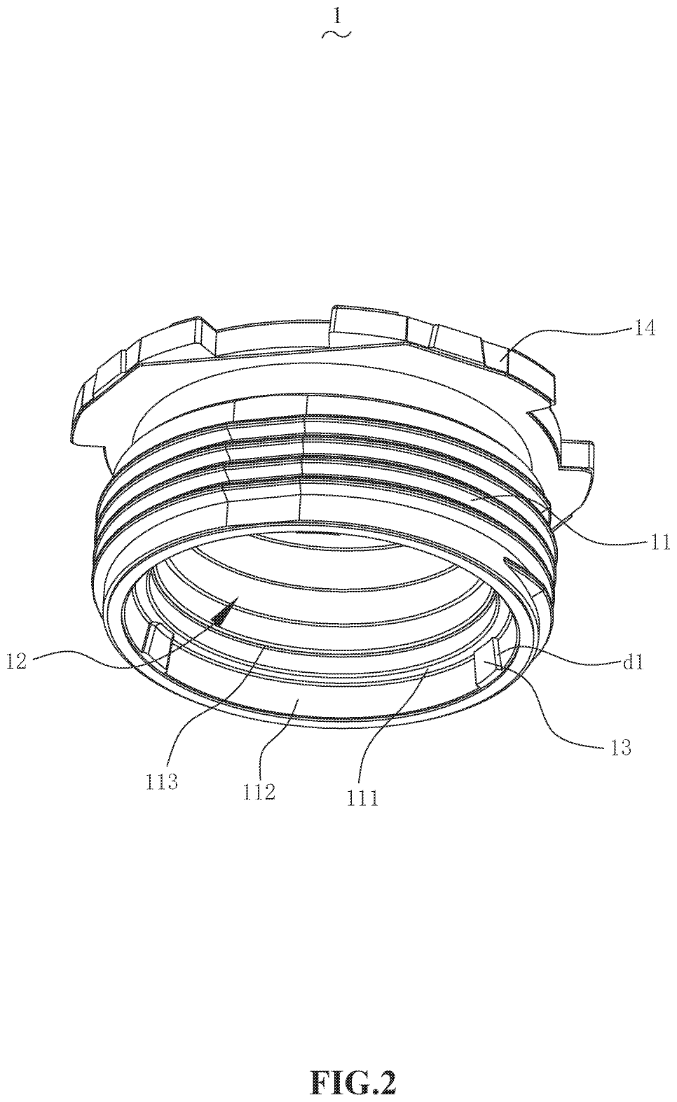

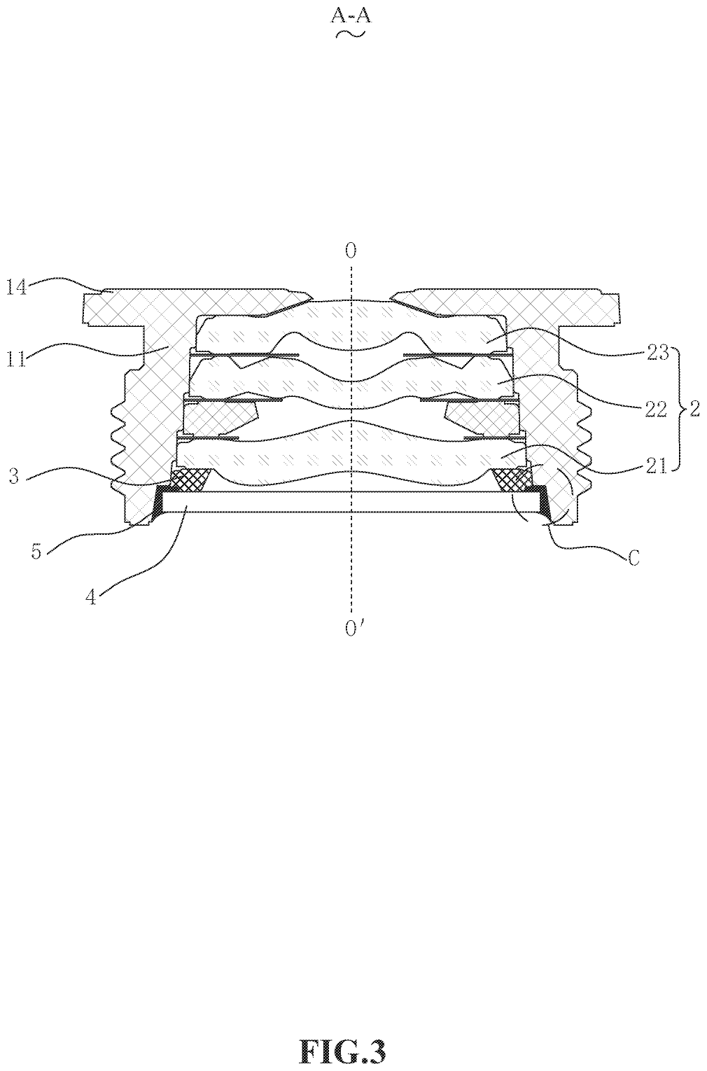

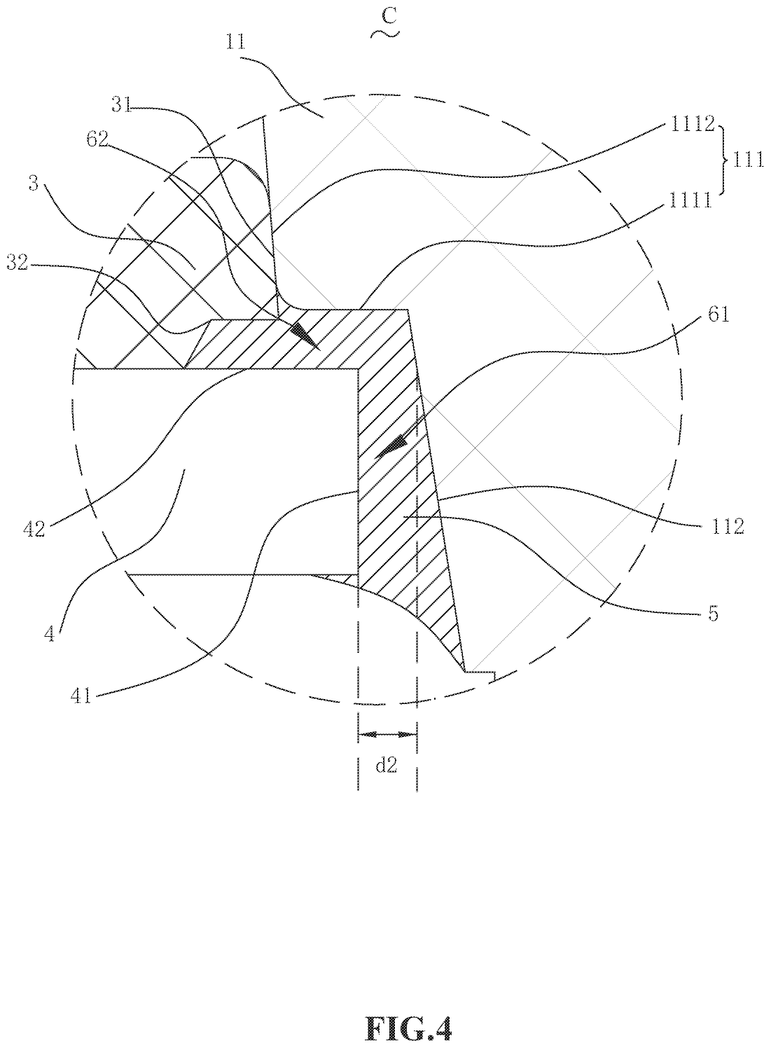

Reference is made to FIGS. 1 to 4, a lens assembly 100 according to the present disclosure includes a lens barrel 1, a lens group 2 with an optical axis OO′ accommodated in the lens barrel 1, a pressure ring 3 arranged on an image side of the lens group 2 and abutting against the lens group 2, and an optical filter 4 abutting the pressure ring 3. An outer diameter of the optical filter 4 is larger than an outer diameter of the pressure ring 3. The lens barrel 1, the pressure ring 3 and the optical filter 4 are bonded by an adhering part 5, and the adhering part 5 is formed by curing adhesive. The lens barrel 1, the pressure ring 3 and the optical filter 4 are connected in one piece by the adhering part 5. In this way, firmness of the bonding between the optical filter 4, the pressure ring 3 and the lens barrel 1 can be ensured, the overall thrust of the lens assembly 100 can be improved, and the reliability of the lens assembly 100 can be increased.

Specifically, the lens barrel 1 includes a cylinder 11 with an accommodating space 12, a plurality of positioning parts 13 arranged to protrude inside the cylinder 11 and close to one end of the cylinder 11, and a protruding plate 14 extending from the other end of the cylinder 11 away from the plurality of positioning parts 13. The pressing ring 3 and the optical filter 4 are completely accommodated in the accommodating space 12.

The cylinder 11 includes a boss 111, an inner wall 112 connected to one end of the boss 111, and a plurality of steps 113 connected to the other end of the boss 111. The inner wall 112 is provided on the end of the cylinder 11 close to the image side, and the plurality of the positioning parts 13 protrude from the inner wall 112 and extend toward the optical axis OO′. The boss 111 includes a platform part 1111 and a side wall part 1112 connected to each other, and the side wall part 1112 faces to the optical axis OO′ and is connected to the plurality of steps 113. The plurality of the positioning parts 13 are distributed in a form of an array and are used for positioning the optical filter 4, which avoids the asymmetry caused by deviation of the center of the optical filter 4 from the optical axis OO′, and reduces possibility of overflowing of adhesive out of the lens barrel 1. In this way, appearance problems such as overflowing of adhesive of the lens assembly 100 can be avoided as much as possible.

The lens group 2 includes a first lens 21, a second lens 22 and a third lens 23 arranged in sequence. The first lens 21 is close to the optical filter 4, and the first lens 21, the second lens 22 and the third lens 23 are installed in the plurality of steps 113, respectively. The pressure ring 3 abuts against an image side of the first lens 21, and the optical filter 4 abuts the pressure ring 3.

The pressing ring 3 includes a first outer wall 31 away from the optical axis OO′ and an adhesive storage groove 32 connected with the first outer wall 31 and close to the image side. The first outer wall 31 abuts the side wall part 1112 of the lens barrel 1.

The optical filter 4 includes a second outer wall 41 away from the optical axis OO′ and an abutting end 42 close to the first lens 21. The second outer wall 41 of the optical filter 4 and the inner wall 112 are arranged to space apart from each other to form an adhesive filling channel 61. The abutting end 42, the adhesive storage groove 32 and the platform part 1111 are enclosed to form an adhesive storage space 62 communicating with the adhesive filling channel 61. During a process of fixing the optical filter 4 by dispensing adhesive, the adhesive penetrates through the adhesive filling channel 61, flows into the adhesive storage space 62, and cures to form the adhering part 5. The adhering part 5 fills the adhesive filling channel 61 and connects the adhesive storage groove 32, the platform part 1111, the inner wall 112 and the optical filter 4 as a whole. In this way, the adhesive storage groove 32, the platform part 1111, the inner wall 112 and the optical filter 4 are firmly connected and have good stability.

In order to ensure that the adhesive can fully fill the adhesive storage space 62, the adhesive filling channel 61 should not be too narrow, that is, a distance d2 between the second outer wall 41 and the inner wall 112 should not be too short. As an improvement, the minimum distance d2 between the second outer wall 41 and the inner wall 112 is greater than 50 microns.

If the distance d2 between the second outer wall 41 and the inner wall 112 is relatively large, during installation of the optical filter 4, the optical filter 4 is prone to shift to left or to right, causing a gap between the optical filter 4 and the lens barrel 1 is not uneven, that is, the gap between the optical filter 4 and the lens barrel 1 is too large in a position and too small in another position. Therefore, in order to ensure the positioning accuracy of the optical filter 4, the optical filter 4 is installed and positioned by the plurality of positioning parts 13.

Specifically, the inner wall 112 is in an arc shape, the plurality of positioning parts 13 are arc-shaped lugs protruding from the inner wall 112 towards the optical axis OO′. The plurality of the positioning parts 13 are arranged in a form of a circular array on the inner wall 112, that is, the plurality of positioning parts 13 are distributed on the inner wall 112 in a form of a circumference and at equal intervals. Where a distance d1 between an end of a positioning part of the plurality of positioning parts 13 away from the inner wall 112 and the inner wall 112 is less than 20 microns.

In this embodiment, three positioning parts 13 are used to position the optical filter 4. In other embodiments, the number of the positioning parts 13 can be increased according to actual requirement, for example, four or six positioning parts 13 can be used to position the optical filter 4, as long as the above-mentioned plurality of positioning parts 13 are distributed in a form of a circular array.

Compared with the related art, the optical filter 4 and the inner wall 112 of the lens barrel 1 of the lens assembly 100 according to the present disclosure are arranged to space apart from each other, so that adhesive can flow to the pressure ring 3 along the inner wall 112 and form the adhering part 5 by curing, thereby the lens barrel 1, the optical filter 4 and the pressure ring 3 can be connected in one piece. In this way, firmness of the bonding between the optical filter 4, the pressure ring 3 and the lens barrel 1 can be ensured, the overall thrust of the lens assembly 100 can be improved, and the reliability of the lens assembly 100 can be increased.

The above description merely involves embodiments of the present disclosure, and it should be noted that, for those skilled in the art, improvements may be made without departing from the inventive concept of the present disclosure, which shall also fall within the protection scope of the present disclosure.

What is claimed is:

1. A lens assembly, comprising:
a lens barrel;
a lens group with an optical axis accommodated in the lens barrel;
a pressure ring arranged on an image side of the lens group and abutting against the lens group; and
an optical filter abutting the pressure ring;
wherein an outer diameter of the optical filter is larger than an outer diameter of the pressure ring, the lens barrel comprises a cylinder with an accommodating space, and the lens group, the pressure ring and the optical filter are accommodated in the accommodating space;
wherein the cylinder comprises a boss and an inner wall connected to the boss, and the inner wall is arranged at an end of the cylinder close to the image side; and
wherein the pressure ring comprises a first outer wall and an adhesive storage groove connected to the first outer wall and close to the image side, the boss comprises a platform part and a side wall part that are connected to each other, and the side wall part abuts against the first outer wall;
the lens assembly further comprises an adhering part, wherein the optical filter and the inner wall are arranged to space apart from each other to form an adhesive filling channel, and the adhering part fills the adhesive filling channel and is connected to the adhesive storage groove, the platform part, the inner wall and the optical filter.

2. The lens assembly according to claim 1, wherein the optical filter comprises a second outer wall, and a distance between the second outer wall and the inner wall is greater than 50 microns.

3. The lens assembly according to claim 1, wherein the lens barrel further comprises a plurality of positioning parts provided on the inner wall, and the optical filter is positioned by the plurality of positioning parts.

4. The lens assembly according to claim 3, wherein the plurality of positioning parts are arranged in a form of a circular array on the inner wall.

5. The lens assembly according to claim 3, wherein a distance between an end of a positioning part of the plurality of positioning parts away from the inner wall and the inner wall is less than 20 microns.

6. The lens assembly according to claim 3, wherein the inner wall is arc-shaped, and the plurality of positioning parts are arc-shaped lugs protruding from the inner wall towards the optical axis.

7. The lens assembly according to claim 2, wherein the lens barrel further comprises a plurality of positioning parts provided on the inner wall, and the optical filter is positioned by the plurality of positioning parts.

8. The lens assembly according to claim 7, wherein the plurality of positioning parts are arranged in a form of a circular array on the inner wall.

9. The lens assembly according to claim 7, wherein a distance between an end of a positioning part of the plurality of positioning parts away from the inner wall and the inner wall is less than 20 microns.

10. The lens assembly according to claim 7, wherein the inner wall is arc-shaped, and the plurality of positioning parts are arc-shaped lugs protruding from the inner wall towards the optical axis.
